(19) United States
(12) Patent Application Publication
(10) Pub. No.: US 2014/0328285 A1
(43) Pub. Date: Nov. 6, 2014

(54) METHOD, APPARATUS AND TERMINAL DEVICE FOR DATA TRANSMISSION OF A WI-FI NETWORK

(71) Applicant: Tencent Technology (Shenzhen) Company Limited, Shenzhen City (CN)

(72) Inventor: Peng SUN, Shenzhen City (CN)

(21) Appl. No.: 14/335,202

(22) Filed: Jul. 18, 2014

Related U.S. Application Data
(63) Continuation of application No. PCT/CN2014/070025, filed on Jan. 2, 2014.

(30) Foreign Application Priority Data
Apr. 23, 2013 (CN) 201310142746.1

(51) Int. Cl. H04W 76/02; H04W 4/00

(52) U.S. Cl. CPC H04W 76/023; H04W 4/008
USPC 370/329

(57) ABSTRACT

The present disclosure relates to the field of Internet technology. A data transmission method, apparatus and terminal device of a Wi-Fi network are provided according to the disclosure. The method including: a first terminal device establishes a communication connection with a second terminal device via the UDP protocol; according to the communication connection, the first terminal device establishes a socket connection with the second terminal device; and the first terminal device sends the transmission data to the second terminal device via the socket connection. The disclosure makes it possible that, once terminal devices are within the same Wi-Fi network, the data transmission may be directly performed between the terminal devices, without dependency on the server. Also, as the data transmission process does not need the operations such as identification, adding friends, and so on, the data transmission process is much easier and faster.

### CROSS-REFERENCE TO RELATED APPLICATIONS

This application is a U.S. continuation application of International Application PCT/CN2014/070025, with an international filing date of Jan. 2, 2014, claiming the priority benefit of Chinese Patent Application No. 201310142746.1 filed on Apr. 23, 2013, the contents of which are both incorporated by reference herein in their entireties for all intended purposes.

### FIELD OF THE INVENTION

The disclosure relates to the field of Internet technology, and in particular, to a method, apparatus and terminal device for data transmission of a Wi-Fi network.

### BACKGROUND

As the development of Internet technology and mobile terminal technology, regularly, people need to transmit various video, audio, and documents, etc between terminal devices. Currently, data transmission between terminal devices is usually achieved via the transiting at the servers. More specifically, the terminal device participating in transmission data needs to be registered at the server, log in the server with a personal account, acquire personal information and friend information, and if the opponent is not a friend, the opponent needs to be added as a friend. While the data transmission process is as follows: data is first transmitted to the server by the sending terminal, then transmitted to the receiving terminal by the server. Therefore, once there is a problem at the server, it would cause many users cannot operate normally. In particular, if a user is urgent to make simple data transmission with nearby users, it would become much more complicated, and cost lots of time and energy.

### SUMMARY OF THE INVENTION

The objective of embodiments of the disclosure is to provide a data transmission method of a Wi-Fi network, to solve the problems such as high association between the existing terminal devices and the server in the data transmission process, the complicated operations, the tedious operation process, and unreliability which refers to the problem of the server would cause many users cannot operate normally.

In order to achieve the objectives above, the embodiments of the disclosure provide the following technical solutions:

One aspect of the disclosure provides a data transmission method of a Wi-Fi network, the data transmission method includes:

establishing, by a first terminal device, a communication connection with a second terminal device via the UDP protocol;

establishing, by the first terminal device, a socket connection with the second terminal device, according to the communication connection; and

sending, by the first terminal device, transmission data to the second terminal device, via the socket connection.

One aspect of the disclosure provides a data transmission method of a Wi-Fi network, the data transmission method includes:

establishing, by a second terminal device, a communication connection with a first terminal device via the UDP protocol;

establishing, by the second terminal device, a socket connection with the first terminal device, according to the communication connection; and

receiving, by the second terminal device, the transmission data sent by the first terminal device, via the socket connection.

One aspect of the disclosure provides a data transmission apparatus of a Wi-Fi network, the data transmission apparatus includes:

a first connection unit, configured to establish a communication connection with a second terminal device via the UDP protocol;

a second connection unit, configured to establish a socket connection with the second terminal device, according to the communication connection; and

a data sending unit, configured to send transmission data from the first terminal device to the second terminal device, via the socket connection.

One aspect of the disclosure provides a terminal device, the terminal device includes said data transmission apparatus of a Wi-Fi network.

One aspect of the disclosure provides a data transmission apparatus of a Wi-Fi network, the data transmission apparatus includes:

a first connection unit, configured to establish a communication connection with a first terminal device via the UDP protocol;

a second connection unit, configured to establish a socket connection with a first terminal device, according to the communication connection; and

a data receiving unit, configured to receive the transmission data sent by the first terminal device, via the socket connection.

One aspect of the disclosure provides a terminal device, the terminal device includes said data transmission apparatus of a Wi-Fi network.

One aspect of the disclosure provides a non-transitory computer readable storage medium encoded with non-transitory machine executable instructions that when executed by a computer, cause the computer to execute a method comprising:

establishing, by a first terminal device, a communication connection with a second terminal device via the UDP protocol;

establishing, by the first terminal device, a socket connection with the second terminal device, according to the communication connection; and

sending, by the first terminal device, transmission data to the second terminal device via the socket connection.

According to the embodiments of the present disclosure, the first terminal device establishes a communication connection with the second terminal device via the UDP protocol; the first terminal device establishes a socket connection with the second terminal device, according to the communication connection; the first terminal device sends transmission data to the second terminal device via the socket connection. The advantageous effects of the above embodiments at least lie in that, for terminal devices that are within the same Wi-Fi network, data transmission may be directly performed between the terminal devices, without dependency on the server. Also, as the data transmission process does not need the operations such as identification, adding friends, and so on, the data transmission process is much easier and faster.

### DESCRIPTION OF THE DRAWINGS

To better illustrate the technical solutions of the embodiments of the present disclosure, brief introduction to the drawings along with the description of the embodiments will be made below. It is obvious that the drawings in the following description are for illustrating exemplary embodiments of the present disclosure, and that a person of ordinary skilled in the art may derive additional drawings based on these figures without paying creative efforts.

FIG. 1 is a structure diagram of application scenario provided by one embodiment of the disclosure;

FIG. 2 is a flow diagram for implementing the data transmission method of a Wi-Fi network provided by one embodiment of the disclosure;

FIG. 3 is a flow diagram for implementing the data transmission method of a Wi-Fi network provided by one embodiment of the disclosure;

FIG. 4 is a flow diagram for implementing the data transmission method of a Wi-Fi network provided by one embodiment of the disclosure;

FIG. 5 is a flow diagram of data transmission process of a Wi-Fi network provided by one embodiment of the disclosure;

FIG. 6 is a flow diagram for implementing the data transmission method of a Wi-Fi network provided by one embodiment of the disclosure;

FIG. 7 is a flow diagram for implementing the data transmission method of a Wi-Fi network provided by one embodiment of the disclosure;

FIG. 8 is a flow diagram for implementing the data transmission method of a Wi-Fi network provided by one embodiment of the disclosure;

FIG. 9 is a structure diagram of the data transmission apparatus of a Wi-Fi network provided by one embodiment of the disclosure;

FIG. 10 is a structure diagram of the data transmission apparatus of a Wi-Fi network provided by one embodiment of the disclosure;

FIG. 11 is a structure diagram of the data transmission apparatus of a Wi-Fi network provided by one embodiment of the disclosure; and

FIG. 12 is a structure diagram of the data transmission apparatus of a Wi-Fi network provided by one embodiment of the disclosure.

### DETAILED DESCRIPTION

To better illustrate the purpose, technical solution and advantages of the present disclosure, the present disclosure will be further described in detail in conjunction with the accompanying drawings and embodiments below. It should be appreciated that the detailed embodiments described herein are only used for explaining, instead of defining the disclosure.

In the present embodiments, a first terminal device establishes a communication connection with a second terminal device via the UDP protocol; the first terminal device establishes a socket connection with the second terminal device, according to the communication connection; and data transmission is executed between the first terminal device and the second terminal device via the socket connection.

The implementations of the disclosure will be described in detail in conjunction with the detailed embodiments in the below:

Refer to FIG. 1, which is a structure diagram of the application scenario provided by an embodiment of the disclosure, area A is an area covered by Wi-Fi network, such area includes at least one terminal device, the terminal device may be smart terminal such as an iPhone, an android phone, etc., or other Mobile Internet Devices (MID), mobile smart terminal, etc. Without detailed limitation of the embodiments of the disclosure, it is assumed that area A includes tablet computer, PC, notebook, PAD terminal device, etc. For each terminal device, a direct communication is accomplished by User Datagram Protocol (UDP) communication method, and then the data transmission is achieved by establishing socket connection. The explanations of the data transmission process between any two terminal devices in are A are as follows:

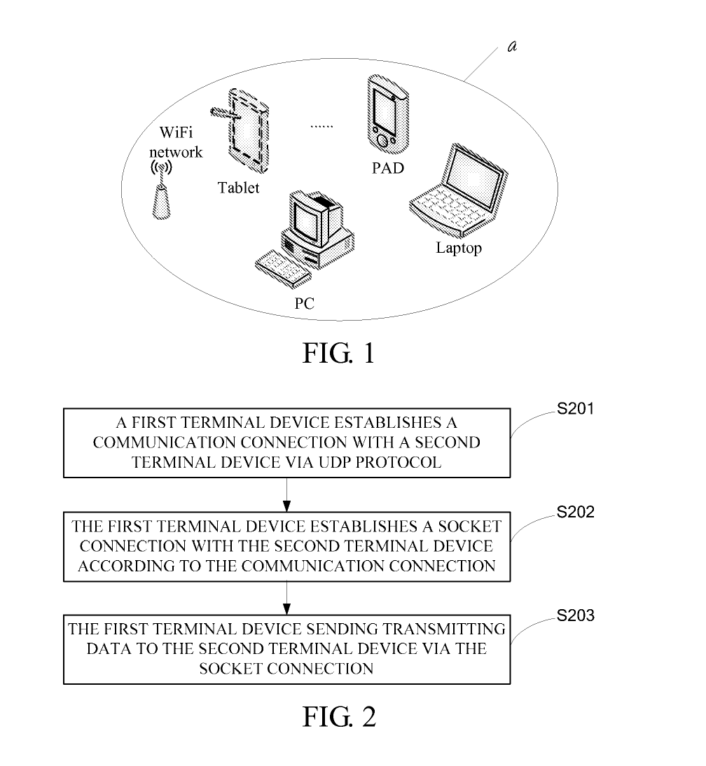

Refer to FIG. 2, which shows a flow diagram for implementing the data transmission method of a Wi-Fi network provided by an embodiment of the disclosure, the detailed illustrations are as follows:

At S201, the first terminal device establishes a communication connection with the second terminal device via the UDP protocol.

In the present embodiment, the first terminal device establishes a communication connection with the second terminal device by LAN broadcasting based on the UDP protocol. A data transmission link may be established between the first terminal device and the second terminal device, according to the communication connection, i.e., S202 is performed.

At S202, the first terminal device establishes a socket connection with the second terminal device, according to the communication connection.

Data transmission may be performed between the first terminal device and the second terminal device via the socket connection.

At S203, the first terminal device sends transmission data to the second terminal device via the socket connection.

In the present embodiment, the first terminal device may send transmission data to the second terminal device via the socket connection, the second terminal device may also send other transmission data to the first terminal device.

In the present embodiment, the transmission data may be data between terminal devices withof a Wi-Fi network, such as file data, game data, query data of the surrounding information of an unfamiliar place, and even social data, etc.

In the present embodiment, the circumstance in which multiple terminal devices are covered by one Wi-Fi network is described, but the Wi-Fi network may not have a base station of hotspot. As long as the Wi-Fi functions of multiple terminal devices are switched on, and the Wi-Fi ranges overlap with each other, the above-mentioned data transmission method may be applied.

In the present embodiment, the first terminal device establishes a communication connection with the second terminal device via the UDP protocol; the first terminal device establishes a socket connection with the second terminal device, according to the communication connection; the first terminal device sends transmission data to the second terminal device via the socket connection. This process makes it possible that once terminal devices are within the same Wi-Fi network, the data transmission may be directly performed between the terminal devices, without dependency on the server. Also as the data transmission process does not need the operations such as identification, adding friends, and so on, the data transmission process is much easier and faster.

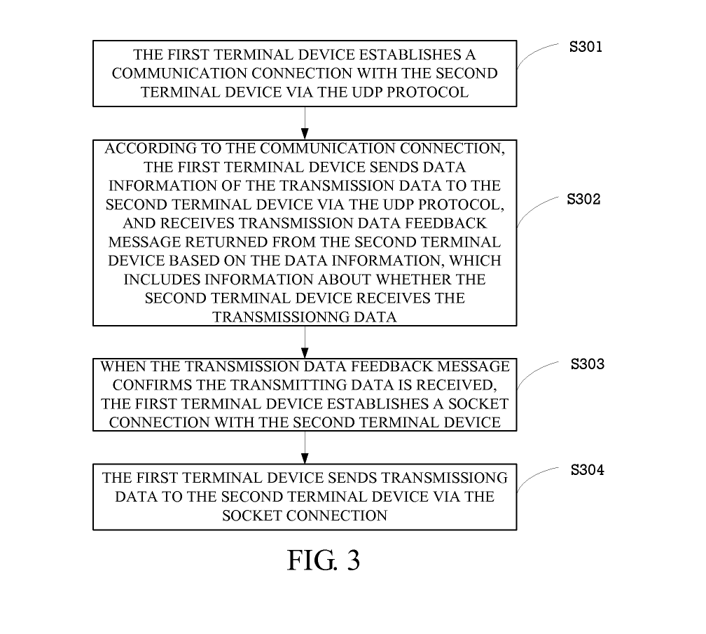

Refer to FIG. 3, which shows a flow diagram for implementing the data transmission method of a Wi-Fi network provided by an embodiment of the disclosure, the detailed illustrations are as follows:

At S301, the first terminal device establishes a communication connection with the second terminal device via the UDP protocol.

At S302, according to the communication connection, the first terminal device sends data information of the transmission data to the second terminal device via the UDP protocol, and receives transmission data feedback message returned from the second terminal device based on the data information, the transmission data feedback message includes information about whether the second terminal device receives the transmission data.

In the present embodiment, the data information may include information of data name, data size, data type, etc.

In the present embodiment, upon receiving the data information, the second terminal device generates the transmission data feedback message, based on the information about whether the transmission data is received, which is input from the second terminal device, and feeds the transmission data feedback message back to the first terminal device.

At S303, when the transmission data feedback message confirms that the transmission data is received, the first terminal device establishes a socket connection with the second terminal device.

In the present embodiment, when the transmission data feedback message confirms that the transmission data is received, S304 is performed; when the transmission data feedback message confirms that the transmission data is not received, the process ends.

At S304, the first terminal device sends transmission data to the second terminal device via the socket connection.

In the present embodiment, the first terminal device establishes the communication connection with the second terminal device via the UDP protocol; the first terminal device sends data information of the transmission data to the second terminal device via the UDP protocol according to the communication connection, and receives transmission data feedback message returned from the second terminal device based on the data information which includes information about whether the second terminal device receives the transmission data; when the transmission data feedback message confirms that the transmission data is received, the first terminal device establishes a socket connection with the second terminal device; the first terminal device sends transmission data to the second terminal device via the socket connection. This process makes it possible that once terminal devices are within the same Wi-Fi network, the data transmission may be directly performed between the terminal devices, without dependency on the server; also as the data transmission process does not need the operations such as identification, adding friends, and so on, the data transmission process is much easier and faster. Also, the data information of the transmission data between the terminal devices is transmitted first, when the transmission data feedback message confirms that the transmission data is received, the socket connection is established and the data transmission is performed, which makes the data transmission process more stable and reliable.

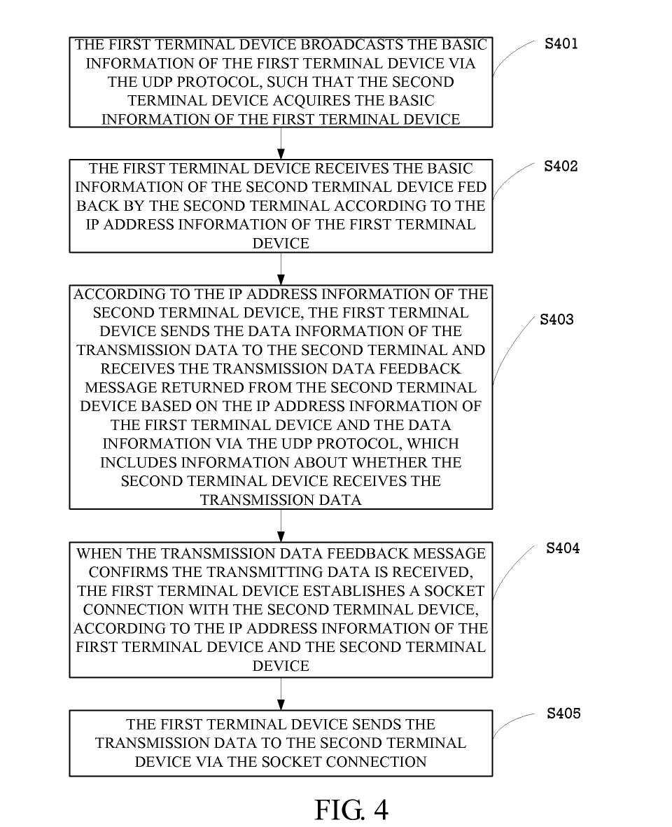

Refer to FIG. 4, which shows a flow diagram for implementing the data transmission method of a Wi-Fi network provided by an embodiment of the disclosure, the detailed illustrations are as follows:

At S401, the first terminal device broadcasts the basic information of the first terminal device based on the UDP protocol, such that the second terminal device acquires the basic information of the first terminal device, wherein the basic information includes IP address information of the first terminal device.

In the present embodiment, the basic information includes at least the IP address information of the first terminal device, it may also include the device information of the first terminal device and the like.

In the present embodiment, the first terminal device broadcasts the basic information of the first terminal device by the way of broadcasting protocol based on the UDP protocol. That is, the basic information of the first terminal device is broadcasted to IP address: 255.255.255.255 through the UDP protocol. At this time, the broadcast is non-directional, all other terminal devices of a Wi-Fi network could acquire a message that the first terminal device is online, and thereby the basic information of the first terminal device is acquired. Therefore, the second terminal device may acquire the basic information of the first terminal device.

At S402, the first terminal device receives the basic information of the second terminal device fed back by the second terminal according to the IP address information of the first terminal device, the basic information includes the IP address information of the second terminal device.

In the present embodiment, other terminal devices feed the basic information of the second terminal device back, according to the IP address information of the first terminal device. The first terminal device receives the basic information fed back by other terminal devices, and thereby acquires the basic information of the terminal device which is currently online. As the first terminal device and the second terminal device have acquired the IP address information of each other, the communication connection between them is established.

At S403, according to the IP address information of the second terminal device, via the UDP protocol, the first terminal device sends the data information of the transmission data to the second terminal and receives the transmission data feedback message returned from the second terminal device based on the IP address information of the first terminal device and the data information, the transmission data feedback message includes information about whether the second terminal device receives the transmission data.

At S404, when the transmission data feedback message confirms that the transmission data is received, the first terminal device establishes a socket connection with the second terminal device, according to the IP address information of the first terminal device and the second terminal device.

At S405, the first terminal device sends the transmission data to the second terminal device via the socket connection.

In the present embodiment, by broadcasting based on the UDP protocol, the first terminal device and the second terminal device establish a connection and acquire IP information from each other, establish a socket connection according to the IP address information, and data transmission is accomplished via the socket connection. This process makes it possible that once terminal devices are within the same Wi-Fi network, the data transmission may be directly performed between the terminal devices, without dependency on the server. Also, as the data transmission process does not need the operations such as identification, adding friends, and so on, the data transmission process is much easier and faster.

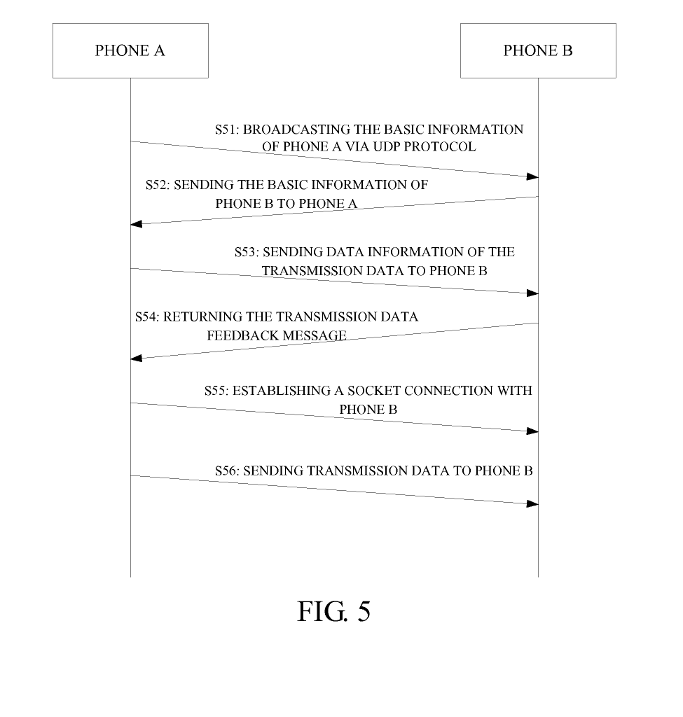

To be better understood, a detailed implementation example is introduced in the following to explain the implementation process of the data transmission method of a Wi-Fi network of the embodiment, which, however, is not limited by the exampled situation of this implementation. It is supposed that within the same Wi-Fi network, this Wi-Fi network includes at least a phone A and a phone B, the interaction process of phone A and phone B is exampled below. Refer to FIG. 5, which is a flow diagram of data transmission process of a Wi-Fi network provided by embodiment 3 of the disclosure:

At S51, phone A broadcasts the basic information of phone A based on the UDP protocol, wherein the basic information includes the IP address information of phone A.

In the present embodiment, phone A broadcasts the basic information (including information of the IP address of phone A, etc.) of this user to IP: 255.255.255.255 via the UDP protocol technology. This stage is the “online broadcasting” of terminal device A, other phones withof a Wi-Fi network could be notified with the message that phone A is online via this “online broadcasting”. At this time, other phones may monitor the online message of phone A. Therefore, phone B may receive the message that phone A is online, meanwhile acquiring the basic information broadcasted from phone A (including information of the IP address of phone A, etc.).

At S52, according to the IP address information of phone A, phone B sends its basic information including the IP address information of phone B to phone A.

In the present embodiment, after being notified that phone A is online, phone B immediately sends the notification that phone B is online in the direction to phone A via UDP network protocol, by utilizing the acquired IP address of phone A. Of course, this notification will carry the basic information of phone B (including information of the IP address of phone B, etc.), this stage is called as “online feedback”, to allow the phone (phone A) which is just online to acquire the information of the online terminal devices. At this time, phone A would receive the information of the online terminal devices accordingly, and of course, it would also acquire the message that phone B is online and the information of phone B. Hence, S53 is performed.

At S53, according to the IP address information of phone B, phone A sends the data information of the transmission data to phone B via the UDP protocol.

In the present embodiment, if phone A wants to send data to phone B, it may send the data information of the transmission data to phone B via the UDP protocol, by utilizing the acquired IP address information of phone B.

At S54, phone B returns the transmission data feedback message based on the IP address information of phone A and the data information, wherein the transmission data feedback message includes the information about whether phone B receives the transmission data.

In the present embodiment, after the data information is received, phone B determines whether it is necessary to receive this file autonomously, and notifies phone A the determination result via the UDP protocol by utilizing the IP of phone A.

At S55, when the transmission data feedback message confirms that the transmission data is received, a socket connection is established between phone A and phone B, according to the IP address information of phone A and phone B;

At S56, phone A sends the transmission data to phone B via the socket connection.

In the present embodiment, if phone B chooses to refuse receiving the transmission data, this operation ends; if phone B chooses to receive the transmission data, phone A will establish the socket connection according to the IP address of phone B, and send the file to phone B via this connection. Phone B receives the transmission data normally.

The above-mentioned flow achieves the effect that: by using UDP network protocol, the files are directly transmitted between phone terminal A and B without the server.

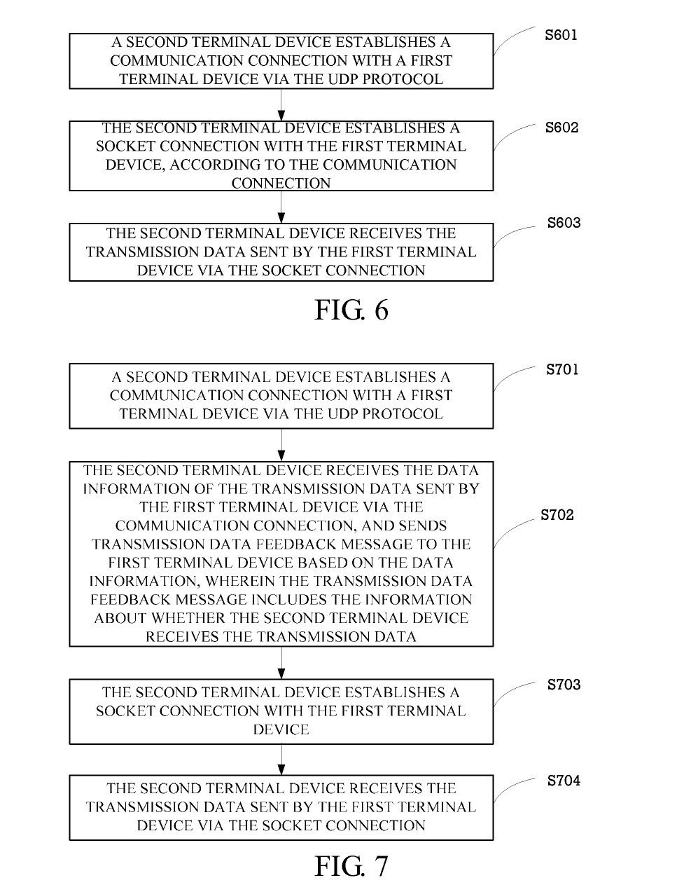

Refer to FIG. 6, which shows a flow diagram for implementing the data transmission method of a Wi-Fi network provided by embodiment 4 of the disclosure, this method is the method at the second terminal side corresponding to that at the first terminal side, the detailed illustrations are as follows:

At S601, a second terminal device establishes a communication connection with a first terminal device via the UDP protocol;

At S602, the second terminal device establishes a socket connection with the first terminal device, according to the communication connection;

At S603, the second terminal device receives the transmission data transferred by the first terminal device via the socket connection.

In the present embodiment, the second terminal device establishes a communication connection with the first terminal device via the UDP protocol; according to the communication connection, the second terminal device establishes a socket connection with the first terminal device; the second terminal device receives the transmission data transferred by the first terminal device via the socket connection. This process makes it possible that once terminal devices are within the same Wi-Fi network, the data transmission may be directly performed between the terminal devices, without dependency on the server. Also as the data transmission process does not need the operations such as identification, adding friends, and so on, the data transmission process is much easier and faster.

Refer to FIG. 7, which shows a flow diagram for implementing the data transmission method of a Wi-Fi network provided by an embodiment of the disclosure, the detailed illustrations are as follows:

At S701, a second terminal device establishes a communication connection with a first terminal device via the UDP protocol;

At S702, the second terminal device receives the data information of the transmission data sent by the first terminal device via the communication connection, and sends transmission data feedback message to the first terminal device based on the data information, wherein the transmission data feedback message includes the information about whether the second terminal device receives the transmission data;

At S703, the second terminal device establishes a socket connection with the first terminal device;

At S704, the second terminal device receives the transmission data sent by the first terminal device via the socket connection.

In the present embodiment, the second terminal device establishes a communication connection with the first terminal device via the UDP protocol; the second terminal device receives the data information of the transmission data sent by the first terminal device via the communication connection, and sends transmission data feedback message to the first terminal device based on the data information, the transmission data feedback message includes the information about whether the second terminal device receives the transmission data; the second terminal device establishes a socket connection with the first terminal device; the second terminal device receives the transmission data sent by the first terminal device via the socket connection. This process makes it possible that once terminal devices are within the same Wi-Fi network, the data transmission may be directly performed between the terminal devices, without dependency on the server. Also, as the data transmission process does not need the operations such as identification, adding friends, and so on, the data transmission process is much easier and faster. Also, the data information of the transmission data between the terminal devices is transmitted first, and when the transmission data feedback message confirms that the transmission data is received, the socket connection is established and the data transmission is proceeded, which makes the data transmission process more stable and reliable.

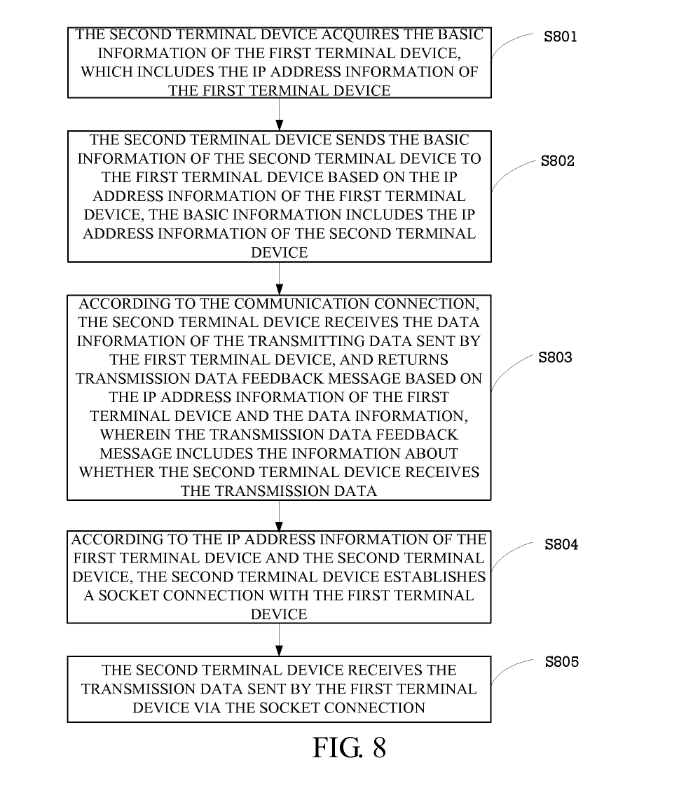

Refer to FIG. 8, which shows a flow diagram for implementing the data transmission method of a Wi-Fi network provided by an embodiment of the disclosure, the detailed illustrations are as follows:

At S801, the second terminal device acquires the basic information of the first terminal device, the basic information includes the IP address information of the first terminal device;

At S802, the second terminal device sends the basic information of the second terminal device to the first terminal device according to the IP address information of the first terminal device, the basic information includes the IP address information of the second terminal device.

At S803, according to the communication connection, the second terminal device receives the data information of the transmission data sent by the first terminal device, and returns transmission data feedback message based on the IP address information of the first terminal device and the data information, wherein the transmission data feedback message includes the information about whether the second terminal device receives the transmission data.

At S804, according to the IP address information of the first terminal device and the second terminal device, the second terminal device establishes a socket connection with the first terminal device.

At S805, the second terminal device receives the transmission data sent by the first terminal device via the socket connection.

In the present embodiment, by broadcasting based on the UDP protocol, the second terminal device and the first terminal device establish a connection and acquire IP information from each other; establish a socket connection according to the IP address information, and data transmission via the socket connection is accomplished. This process makes it possible that once terminal devices are within the same Wi-Fi network, the data transmission may be directly performed between the terminal devices, without dependency on the server. Also, as the data transmission process does not need the operations such as identification, adding friends, and so on, the data transmission process is much easier and faster.

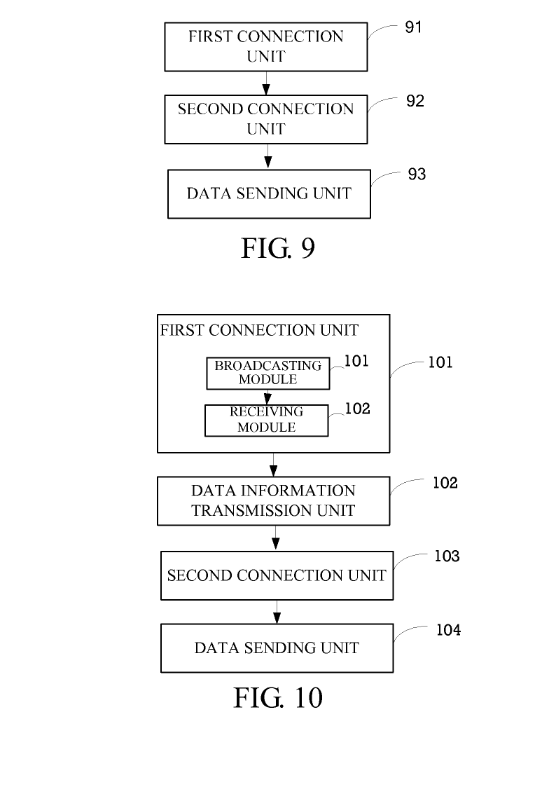

FIG. 9 shows a structure diagram of the data transmission apparatus of a Wi-Fi network provided by an embodiment of the disclosure. To make the description convenient, only the part in association with the present embodiment is shown. This apparatus may be a software unit, a hardware unit, or a combination unit of software and hardware which resides within the terminal device.

The apparatus includes: a first connection unit 91, a second connection unit 92 and a data sending unit 93.

The first connection unit 91 is configured to establish a communication connection with the second terminal device via the UDP protocol;

The second connection unit 92 is configured to establish a socket connection with the second terminal device, according to the communication connection;

The data sending unit 93 is configured to send the transmission data to the second terminal device via the socket connection.

The data transmission apparatus of a Wi-Fi network provided by the present embodiment may be used in the responding method embodiment above, the detailed description of the method embodiment is described above, further illustrations will be omitted.

FIG. 10 shows a structure diagram of the data transmission apparatus of a Wi-Fi network provided by an embodiment of the disclosure. To make the description convenient, only the part in association with the present embodiment is shown. This apparatus may be a software unit, a hardware unit, or a combination unit of software and hardware which resides within the terminal device.

The apparatus includes: a first connection unit 101, a data information transmission unit 102, a second connection unit 103 and a data sending unit 104.

In this embodiment, optionally, the first connection unit 101 includes a broadcasting module 1011 and a receiving module 1012.

The broadcasting module 1011 is configured to broadcast the basic information of the first terminal device via the UDP protocol, such that the second terminal device could acquire the basic information of the first terminal device, wherein said basic information includes the IP address information of the first terminal device.

The receiving module 1012 is configured to receive the basic information of the second terminal device fed back by the second terminal device according to the IP address information of the first terminal device, the basic information including the IP address information of the second terminal device.

Optionally, the data information transmission unit 102 is specifically configured, such that according to the IP address information of the second terminal device, the first terminal device sends the data information of the transmission data to the second terminal and receives the transmission data feedback message returned from the second terminal device, based on the IP address information of the first terminal device and the data information via the UDP protocol.

Specifically, the second connection unit 103 is configured to establish a socket connection with the second terminal device, according to the IP address information of the first terminal device and the second terminal device, when the transmission data feedback message confirms that the transmission data is received.

The data transmission apparatus of a Wi-Fi network provided by the present embodiment may be used in the method embodiments above, the detailed description of the method embodiments is described above, further illustrations will be omitted.

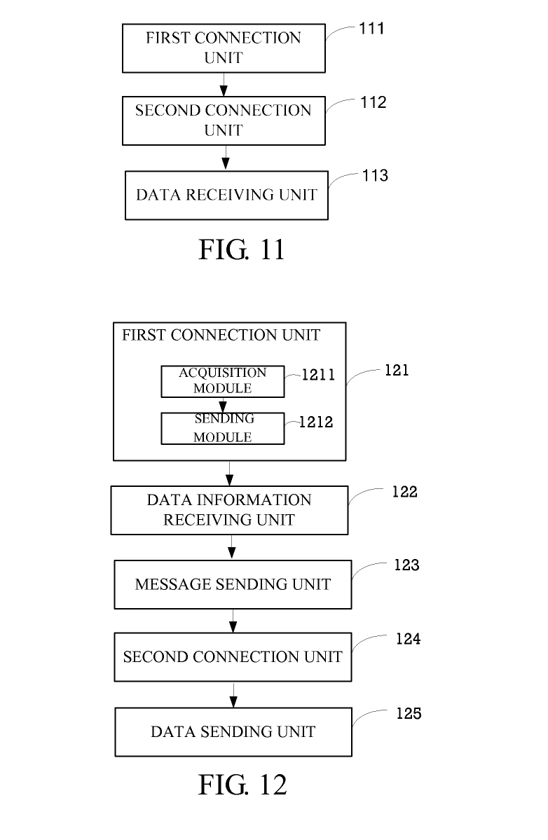

FIG. 11 shows a structure diagram of the data transmission apparatus of a Wi-Fi network provided by an embodiment of the disclosure. To make the description convenient, only the part in association with the present embodiment is shown. This apparatus may be a software unit, a hardware unit, or a combination unit of software and hardware which resides within the terminal device.

The apparatus includes: a first connection unit 111, a second connection unit 112 and a data receiving unit 113.

The first connection unit 111 is configured to establish a communication connection with the first terminal device via the UDP protocol;

The second connection unit 112 is configured to establish a socket connection with the first terminal device according to the communication connection;

The data receiving unit 113 is configured to receive the transmission data sent by the first terminal device via the socket connection.

The data transmission apparatus of a Wi-Fi network provided by the present embodiment may be used in the method embodiment above, the detailed description of the method embodiments is described above, further illustrations will be omitted.

FIG. 12 shows a structure diagram of the data transmission apparatus of a Wi-Fi network provided by an embodiment of the disclosure. To make the description convenient, only the part in association with the present embodiment is shown. This apparatus may be a software unit, a hardware unit, or a combination unit of software and hardware which resides within the terminal device.

The apparatus includes: a first connection unit 121, a data information receiving unit 122, a message sending unit 123, a second connection unit 124 and a data sending unit 125.

In the present embodiment, optionally, the first connection 121 includes an acquisition module 1211 and a sending module 1212.

The acquisition module 1211 is configured to acquire the basic information of the first terminal device, which includes the IP address information of the first terminal device;

The sending module 1212 is configured to send the basic information of the second terminal device to the first terminal device, according to the IP address information of the first terminal device, wherein said basic information includes the IP address information of the second terminal device.

Optionally, the data information receiving unit 122 is also configured to receive the data information of the transmission data sent by the first terminal device;

the message sending unit 123 is configured to send the transmission data feedback message to the first terminal device according to said data information, wherein the transmission data feedback message includes information about whether the second terminal device receives the transmission data.

Optionally, the message sending unit 123 is specifically configured to return the transmission data feedback message according to the IP address information of the first terminal device and the data information;

Specifically, the second connection 124 is configured to establish a socket connection with the first terminal device according to the IP address information of the first terminal device and the second terminal device.

The data transmission apparatus of a Wi-Fi network provided by the present embodiment may be used in the method embodiments above, the detailed description of the method embodiments is described above, further illustrations will be omitted.

It should be noted that each unit included in the above embodiments is divided by logic function, but not limited to this, as long as the corresponding functions can be achieved. Besides, the detailed name of each function unit is also used to distinguish from each other, rather than to limit the claimed scope of the disclosure.

Furthermore, it will be appreciated by those skilled in the art that all or parts of the procedures in the above-mentioned methods of the embodiments may be implemented by using program to instruct relevant hardware, the corresponding hardware could be stored in a computer readable storage medium, such as ROM/RAM, magnetic disk or optical disk, etc.

Memory includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory may optionally include one or more storage devices remotely located from the CPU(s). Memory, or alternatively the non-volatile memory device(s) within memory, comprises a non-transitory computer readable storage medium.

The above embodiments are just some preferred embodiments of the present disclosure, and not used to limit the disclosure. Any modifications, equivalent replacements or improvements that fall within the spirit and principle of the present disclosure should be embraced in the protection scope of the disclosure.

What is claimed is:

1. A method for data transmission of a Wi-Fi network, comprising:
establishing, by a first terminal device, a communication connection with a second terminal device via the UDP protocol;
establishing, by the first terminal device, a socket connection with the second terminal device, according to the communication connection; and
sending, by the first terminal device, transmission data to the second terminal device via the socket connection.

2. The method according to claim 1, wherein, before establishing, by the first terminal device, a socket connection with the second terminal device, the method further comprises:
sending, by the first terminal device, data information of the transmission data to the second terminal device, and receiving transmission data feedback message returned from the second terminal device according to the data information via the UDP protocol, wherein the transmission data feedback message comprises information about whether the second terminal device receives the transmission data;
establishing, by the first terminal device, a socket connection with the second terminal device comprises:
when the transmission data feedback message confirms that the transmission data is received, establishing, by the first terminal device, the socket connection with the second terminal device.

3. The method according to claim 1, wherein establishing, by a first terminal device, a communication connection with a second terminal device via the UDP protocol comprising:
broadcasting, by the first terminal device, basic information of the first terminal device based on the UDP protocol, such that the second terminal device acquires the basic information of the first terminal device, wherein the basic information comprises IP address information of the first terminal device;
receiving, by the first terminal device, the basic information of the second terminal device fed back by the second terminal according to the IP address information of the first terminal device, wherein the basic information comprises the IP address information of the second terminal device.

4. The method according to claim 3, wherein sending, by the first terminal device, data information of the transmission data to the second terminal device, and receiving transmission data feedback message returned from the second terminal device according to the data information via the UDP protocol comprises:
sending, by the first terminal device, the data information of the transmission data to the second terminal according to the IP address information of the second terminal device, and receiving the transmission data feedback message returned from the second terminal device according to the IP address information of the first terminal device and the data information via the UDP protocol;
establishing, by the first terminal device, a socket connection with the second terminal device comprises:
establishing, by the first terminal device, the socket connection with the second terminal device, according to the IP address information of the first terminal device and the IP address information of the second terminal device.

5. A method for data transmission of a Wi-Fi network, comprising:
establishing, by a second terminal device, a communication connection with a first terminal device via the UDP protocol;
establishing, by the second terminal device, a socket connection with the first terminal device, according to the communication connection; and
receiving, by the second terminal device, transmission data sent by the first terminal device via the socket connection.

6. The method according to claim 5, wherein, before establishing, by a second terminal device, a communication connection with a first terminal device via the UDP protocol, the method further comprises:
receiving, by the second terminal device, data information of the transmission data sent by the first terminal device;
sending, by the second terminal device, transmission data feedback message to the first terminal device according to the data information, wherein the transmission data feedback message comprises the information about whether the second terminal device receives the transmission data.

7. The method according to claim 5, wherein establishing, by a second terminal device, a communication connection with a first terminal device via the UDP protocol comprising:
acquiring, by the second terminal device, basic information of the first terminal device, wherein the basic information comprises IP address information of the first terminal device;
sending, by the second terminal device, the basic information of the second terminal device to the first terminal device according to the IP address information of the first terminal device, wherein the basic information comprises IP address information of the second terminal device.

8. The method according to claim 7, wherein sending, by the second terminal device, transmission data feedback message to the first terminal device according to the data information comprising:
returning, by the second terminal device, the transmission data feedback message according to the IP address information of the first terminal device and the data information;
establishing, by the second terminal device, a socket connection with the first terminal device comprising:
establishing, by the second terminal device, the socket connection with the first terminal device, according to the IP address information of the first terminal device and the IP address information of the second terminal device.

9. An apparatus for data transmission of a Wi-Fi network, comprising:
a first connection unit, configured to establish a communication connection with a second terminal device via the UDP protocol;
a second connection unit, configured to establish a socket connection with the second terminal device, according to the communication connection; and
a data sending unit, configured to send transmission data to the second terminal device, via the socket connection.

10. The apparatus for data transmission according to claim 9, wherein the apparatus further comprising:
a data information transmission unit, configured to send data information of the transmission data to the second terminal device, and receive transmission data feedback message returned from the second terminal device according to the data information, via the UDP protocol, wherein transmission data feedback message comprises information about whether the apparatus for data transmission receives the transmission data;
the second connection unit is configured to establish the socket connection with the second terminal device, when the transmission data feedback message confirms that the transmission data is received.

11. The apparatus for data transmission according to claim 9, wherein the apparatus further comprising:
a broadcasting module, configured to broadcast basic information of the apparatus for data transmission via the UDP protocol, such that the second terminal device acquires the basic information of the apparatus for data transmission, wherein the basic information comprises the IP address information of the apparatus for data transmission;
a receiving module, configured to receive basic information of the second terminal device fed back by the second terminal device according to the IP address information of the apparatus for data transmission, wherein the basic information comprises the IP address information of the second terminal device.

12. The apparatus for data transmission according to claim 11, wherein, the data information transmission unit is configured to send the data information of the transmission data to the second terminal according to the IP address information of the second terminal device, and receive the transmission data feedback message returned from the second terminal device according to the IP address information of the apparatus for data transmission and the data information, via the UDP protocol;
the second connection unit is configured to establish the socket connection with the second terminal device according to the IP address information of the apparatus for data transmission and the IP address information of the second terminal device, when the transmission data feedback message confirms that the transmission data is received.

13. An apparatus for data transmission of a Wi-Fi network, comprising:
a first connection unit, configured to establish a communication connection with a first terminal device via the UDP protocol;
a second connection unit, configured to establish a socket connection with the first terminal device, according to the communication connection;
a data receiving unit, configured to receive transmission data sent by the first terminal device, via the socket connection.

14. The apparatus for data transmission according to claim 13, wherein the apparatus further comprising:
a data information receiving unit, configured to receive data information of the transmission data sent by the first terminal device;
a message sending unit, configured to send transmission data feedback message to the first terminal device according to the data information, wherein the transmission data feedback message comprises information about whether the apparatus for data transmission receives the transmission data.

15. The apparatus for data transmission according to claim 13, wherein the first connection unit comprising:
a acquisition module, configured to acquire basic information of the first terminal device, wherein the basic information comprises IP address information of the first terminal device;
a sending module, configured to send basic information of the apparatus for data transmission to the first terminal device according to the IP address information of the first terminal device, wherein the basic information comprises the IP address information of the apparatus for data transmission.

16. The apparatus for data transmission according to claim 15, wherein, the message sending unit is configured to return the transmission data feedback message according to the IP address information of the first terminal device and the data information;
the second connection unit is configured to establish the socket connection with the first terminal device according to the IP address information of the first terminal device and the IP address information of the apparatus for data transmission.
